(19) United States
(12) Patent Application Publication
(10) Pub. No.: US 2008/0172382 A1
(43) Pub. Date: Jul. 17, 2008

(54) Security Component for Use With an Internet Browser Application and Method and Apparatus Associated Therewith

(76) Inventor: Michael Hugh Prettejohn, Bath (GB)

Correspondence Address: Pearl Cohen Zedek Latzer, LLP, 1500 Broadway, 12th Floor, New York, NY, 10036, US

(21) Appl. No.: 10/593,153

(22) PCT Filed: Mar. 15, 2005
(86) PCT No.: PCT/GB2005/000978

§ 371 Date: Feb. 21, 2008

(30) Foreign Application Priority Data
Mar. 16, 2004 (GB) 0405901.0
Jul. 26, 2004 (GB) 0416612.0

(51) Int. Cl. G06F 17/30; G06F 7/00

(52) U.S. Cl. 707/6; 707/9; 707/E17.001; 707/E17.01

(57) ABSTRACT

A security component for use with an Internet browser application which displays Internet resources in response to receiving resource locators specifying the Internet resources is disclosed. The security component comprises means for receiving a resource locator from the browser application and means for providing a security alert if the resource locator fulfils one or more criteria. The security component may be a plug-in or toolbar for a web browser application. A security information server and a method for providing security information are also disclosed.

This invention relates to a security component for use with an Internet browser application.

Use of the Internet, and in particular of the World Wide Web (WWW) and e-mail, has increased rapidly in recent years. The World Wide Web is frequently used not only for informational purposes but also for commercial transactions, for example Internet shopping. Internet banking—the online management of financial accounts—has also become increasingly popular. As a result, various forms of computer crime, such as theft of credit card details from e-commerce web sites, and fake or fraudulent e-mails and web sites are also becoming more widespread.

An increasingly common type of online fraud involves criminals who fraudulently obtain sensitive access information such as user names and passwords for online banking services. One way this is achieved is by persuading users to reveal such access information through fake web pages and e-mails. Such web pages and e-mails are typically designed to appear as if they are associated with the relevant bank or other organisation, for example by use of authentic logos and familiar graphical design. Attempts to obtain sensitive information in this way are often called “phishing” attacks.

“Phishing” is a name derived from the notion of “fishing for information”, and “phreaking”, a term used in the 1980's for the process of hacking phone networks and systems to gain access to free calls, or control over parts of the telephony system. In a successful phishing attack, users of online banking services are tricked into disclosing their bank account details, so that the attacker may then log into their Internet bank and transfer their funds.

Organisations which are not banks, but which have accounts that allow the customer to administer money or other tokens of value are also affected by these fraudulent schemes; this includes credit card companies, credit unions, exchanges, and some Internet retail sites. Amazon, Paypal, Visa, and Ebay are some non-bank sites that have been attacked to date.

Phishing is a highly scalable and attractive opportunity for fraudsters; many people in the civilized world now have Internet enabled bank accounts, and under normal circumstances they offer a more pleasant and more convenient user experience than visiting a bank branch or telephoning a bank call centre. Many businesses also have Internet enabled bank accounts. Accordingly a very significant amount of wealth is accessible via web based banking systems, typically protected by a username and password and other textual tokens supplied over the web by the account holder.

The technology required to construct a phishing fraud is minimal. Conventionally, the fraudster constructs an HTML e-mail message with forged e-mail headers indicating that the e-mail has come from the bank, and asks for the recipient to confirm their bank account username and password. To make the request appear more authentic, the mail usually includes a link to a web server which opens a new window with the bank's own web site (not a copy, but the actual site), and asks for the account details in a separate window, hosted on the attacker's server.

Phishing web sites hosted at reasonably reputable hosting companies will usually be taken down quickly once complaints arrive. Therefore, the attacker's server will often be hosted at a company which is paid to ignore complaints about the fraud; some unscrupulous hosting companies in certain countries are known to sell “bullet proof hosting” as a service, meaning that they will endeavour to keep the site running despite requests to close it down from outside of their own jurisdiction. The attacker's server may also be hosted on a computer that the attacker has broken into, without the owner's knowledge.

There are no dependable, publicly available statistics on how many of a bank's customers receiving phishing e-mails actually respond to them, but the fact that the largest UK banks have taken their entire banking sites offline during some phishing attacks indicates that the fraudsters are enjoying a non-trivial degree of success.

Although, as mentioned above, phishing attacks tend to rely on the visual appearance of fake web sites to fool the victim into believing that the web site is authentic, the URL of the fake web site is also often designed to deceive.

Usually, a fake web site's URL is chosen to appear reasonably authentic, for example by using domain and/or host names which are textually similar to those of the bank or other organisation.

In some cases, attackers have also used special characters to encode URLs in deceptive ways. For example, to make the URL appear plausible, attackers have in the past been known to include an “@” sign in the URL, where the text to the left of the “@” is the name of the site to which the victim is expecting to connect, and the text to the right of it is the actual location of the attacker's site.

When the HTTP protocol was originally designed, the “@” character was intended to denote a username at a particular site, as in, for example, “http://sir.tim.berners-lee@www.w3.org”, where “sir.tim.berners-lee” is the username, and “www.w3.org” is the name of the web site.

However, URL encoded usernames have never been widely used, with web sites typically using authentication details such as usernames and passwords and/or cookies to administer user sessions and state, and “@” in URLs has almost exclusively been used for tricks, jokes, and fraud attempts.

Recently, a bug in Microsoft's Internet Explorer™ became widely publicised whereby if a URL encoded %01 character is placed in the URL it hides a subsequent character from view, as in the following URL used to attack customers of Barclays Bank:

http://ibank.barclays.co.uk %01%01%01%01% 01%01%01%01%01%01%01%01%01%01%01%01%01%01%01%01%01%01%01%01%01%0%77%77%77%2E %6E %65%77%79%65%72%73%6D %2E %63%6F % 6D:%38%30%31%2C %2C %6C %6F %67%6F %6E %2C %30%30%2E %70%68%70

The ‘%01’ characters exploits the bug in Microsoft's Internet Explorer web browser, thereby obscuring the appearance of the URL. The encoded characters make it difficult for recipients to spot the “@” sign that gives away the concealed URL of the target web page. In the above example, the URL the user sees displayed in the browser window will be “http://ibank.barclays.co.uk”, whereas the real URL of the web page being viewed is actually “http://www.newyersm.com:80/1,logon,00.php”.

Internet browser applications typically display an indication of whether a web page being accessed is “secure”, that is to say, whether communication between the browser and the web server is encrypted. For example, the browser window of Microsoft's Internet Explorer™ comprises a status bar which, amongst other things, displays a lock symbol when an SSL web site is being accessed. However, this information only indicates that the communication between the browser and the server is protected. Furthermore this information can easily be missed or ignored by the user, who may not be aware of its significance. A user is particularly likely to fail to notice the absence of the lock symbol when visiting what appears to be a very familiar web site. Furthermore, if a fake web site is implemented as an SSL site, the lock symbol would be displayed, reassuring the user into believing that the site is safe.

As mentioned above, in some fraudulent schemes the authentic web site of the financial institution is displayed, with a pop-up window requesting the relevant information. Since pop-up windows are frequently displayed without window features such as toolbars and status lines, the user might believe they are accessing the authentic website although the pop-up window is in fact not associated with the authentic SSL site displayed behind it.

It is therefore an object of the present invention to alleviate some of the above problems.

Accordingly, in a first aspect of the invention, there is provided a security component for use with an Internet browser application which displays Internet resources in response to resource locators specifying the Internet resources, the security component being adapted to operate alongside the Internet browser application at a user terminal; the security component comprising: means for storing a plurality of resource locator patterns, each resource locator pattern matching one or more resource locators relating to Internet resources known or believed to be associated with security risks; means for receiving a resource locator from the browser application; means for comparing the received resource locator to the stored resource locator patterns; and means for providing a security alert if the received resource locator matches one of the stored resource locator patterns.

In this way, users can be provided with improved security when accessing resources on the Internet.

The Internet browser application may, for example, be a web browser for browsing the World Wide Web. The term “Internet resources” preferably includes any type of resource available on the Internet, including web pages (for example in HTML format), and other document and media files, such as audio and video data files. Resource locators may, for example, be in the form of Uniform Resource Locators (URL). Resource locators may also be in the form of encoded representations of URLs. For example, part or all of the URL may be encoded as a check sum or hash code.

The resource locators are preferably character strings and the resource locator patterns are preferably character patterns. Character patterns preferably specify characters or character sequences, and a character pattern is preferably considered to match resource locators which include those characters or character sequences. The security component is preferably adapted to process a pattern comprising one or more wildcards or placeholders. A wildcard or placeholder may, for example, be used to match a pattern to a resource locator which includes an arbitrary character or character sequence in place of the wildcard or placeholder. This can allow for greater flexibility in specifying resource locators to which access is to be restricted, and can also allow resource locators containing unusual or suspicious characters to be identified, leading to improved security. The component preferably further comprises means for transmitting a representation of the resource locator to a security information server, and means for receiving security information relating to the resource locator from the security information server. This can provide a more flexible way of obtaining security information relating to a resource locator. The representation of the resource locator may simply be the resource locator itself, or may be an encoding of the resource locator, comprising, for example, a check sum or hash code of some or all of the resource locator. The security information may suitably comprise a risk rating and/or IP registration information. In this way, suspicious resources can be more easily identified. To further enhance the security, the alerting means may be adapted to prevent the Internet browser application from displaying the Internet resource specified by the resource locator.

In a further aspect of the invention, there is provided a security component for use with an Internet browser application which displays Internet resources in response to resource locators specifying the Internet resources; the security component comprising means for receiving a resource locator from the browser application; means for transmitting a representation of the resource locator to a remote server; means for receiving IP registration information relating to the resource locator from the remote server; and means for displaying the IP registration information. This can enable a user to better judge the security of a resource to which a resource locator refers.

In a further aspect of the invention, there is provided a security information server comprising: a database of security information relating to Internet locations; means for receiving a security information request comprising a representation of a resource locator from a user terminal; means for retrieving security information relating to the resource locator from the database; and means for transmitting the security information to the user terminal.

In this way, a more efficient way of managing and distributing security information can be provided. The term “Internet location” preferably refers to an Internet domain, sub-domain or host, to an IP address, to an Internet page or Internet site, or to any other suitable Internet information source unit.

Advantageously, the database may be adapted to store a plurality of resource locator patterns, each resource locator pattern matching one or more resource locators relating to Internet resources known or believed to be associated with security risks, the security information server preferably further comprising means for receiving pattern version information from a user terminal specifying the version of a local copy of the resource locator patterns held at the user terminal, and means for transmitting pattern update information to the user terminal in dependence on the version information to update the local copy of the resource locator patterns. In this way, user terminals cooperating with the security information server in a distributed security system can be kept up-to-date more efficiently. The security information server preferably further comprises means for receiving an indication of a suspected security risk relating to a specified resource locator from a user terminal; and means for adding a resource locator pattern matching the specified resource locator to the stored resource locator patterns. This can enable efficient sharing of security information between user terminals and the security information server.

The database is preferably adapted to store information relating to suspected security vulnerabilities associated with an Internet location. This can enable a more accurate assessment of the security of an Internet location. For the same reason, the database is preferably adapted to store registration information relating to a plurality of IP addresses, and the retrieving means is adapted to retrieve registration information relating to an IP address associated with the received resource locator representation.

In a further aspect of the invention, there is provided a method of providing security information to a user of an Internet browser application which displays Internet resources in response to resource locators specifying the Internet resources, the browser application residing at a user terminal, the method comprising: storing, at the user terminal, a plurality of resource locator patterns, each resource locator pattern matching one or more resource locators relating to Internet resources known or believed to be associated with security risks; receiving a resource locator from the browser application; comparing the resource locator to the stored resource locator patterns; and providing a security alert if the resource locator matches one of the stored resource locator patterns.

In a further aspect of the invention, there is provided a method of providing security information to a user accessing via the Internet accounts for holding or managing money or other tokens of value, comprising: storing domain names and/or IP address information relating to trusted Internet sites providing access to such accounts; receiving a resource locator specifying an Internet resource requested by the user; determining whether the resource locator relates to a trusted Internet site by comparing a domain name or IP address associated with the resource locator to the stored domain names and/or IP address information; and outputting a corresponding indication to the user if it is determined that the resource locator does relate to a trusted Internet site.

The invention also provides a plug-in or toolbar for an Internet browser application comprising a security component as described herein and/or adapted to carry out a method as described herein.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

The invention extends to methods and/or apparatus substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:—

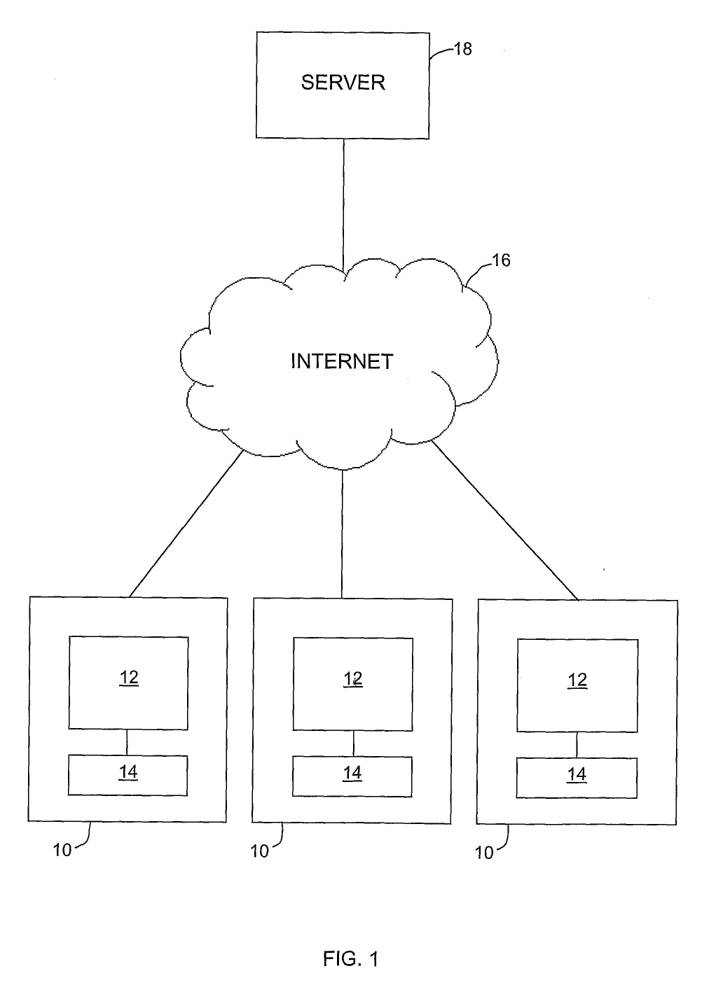

FIG. 1 gives an overview of the architecture of a security system;

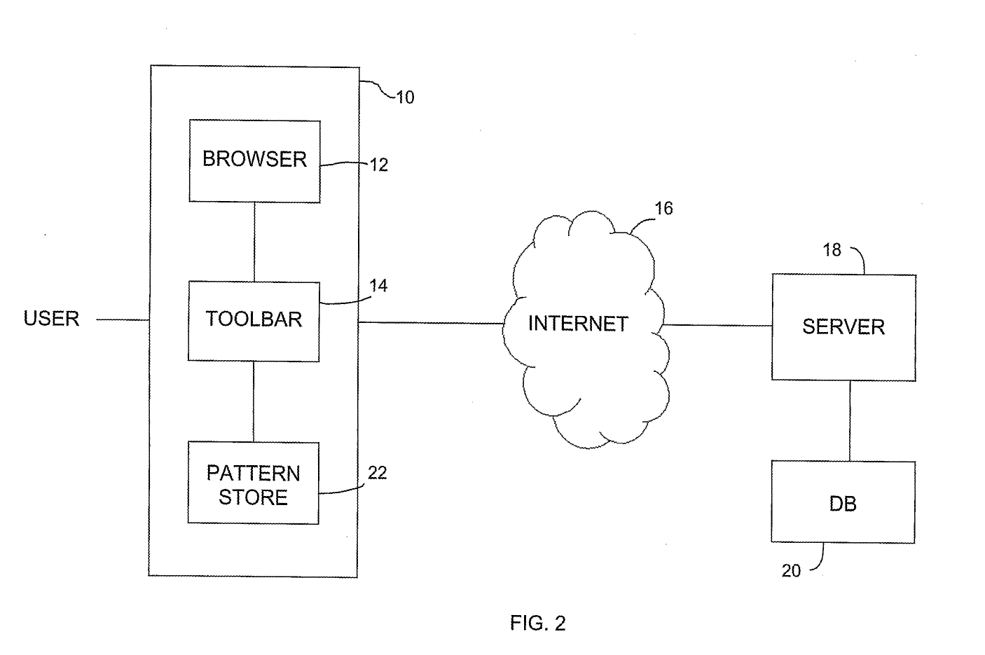

FIG. 2 illustrates the security system of FIG. 1 in greater detail;

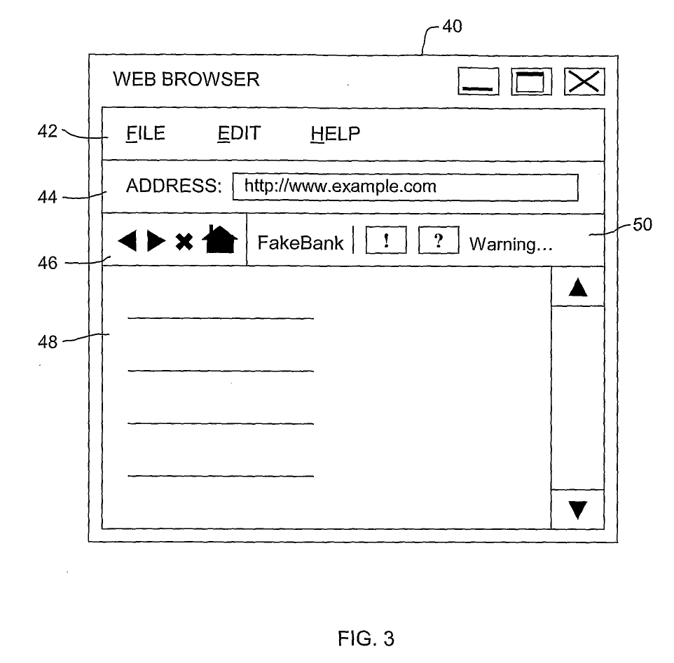

FIG. 3 is a simplified representation of the visual appearance of a web browser window using a security toolbar;

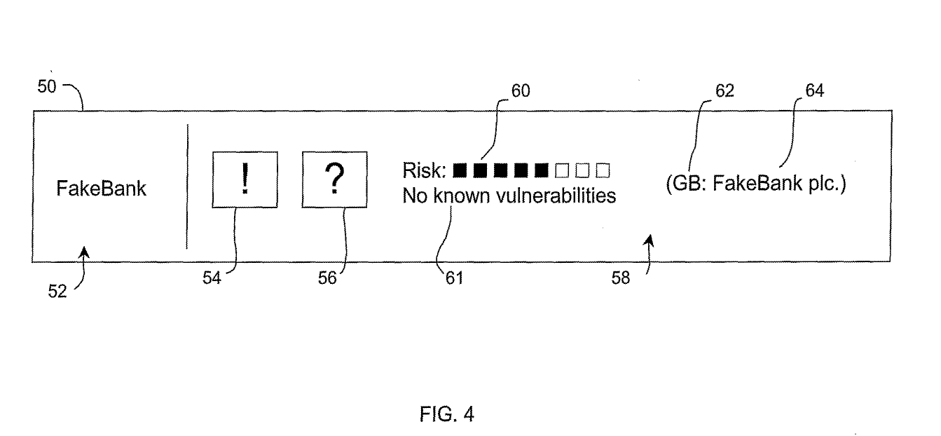

FIG. 4 is a simplified representation of the visual appearance of the security toolbar of FIG. 3;

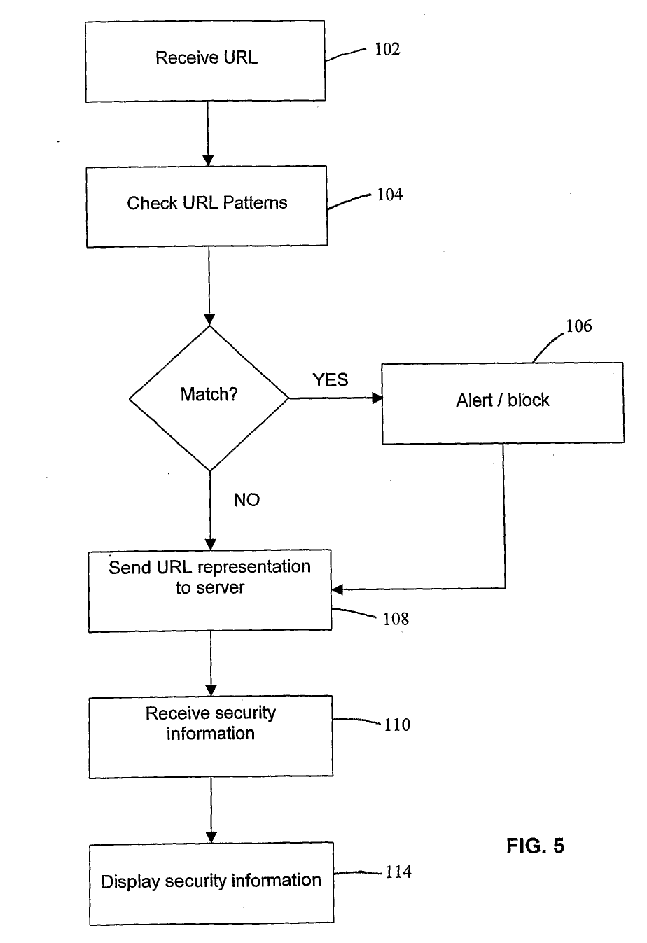

FIG. 5 is a flow diagram illustrating the processing performed by the security toolbar; and

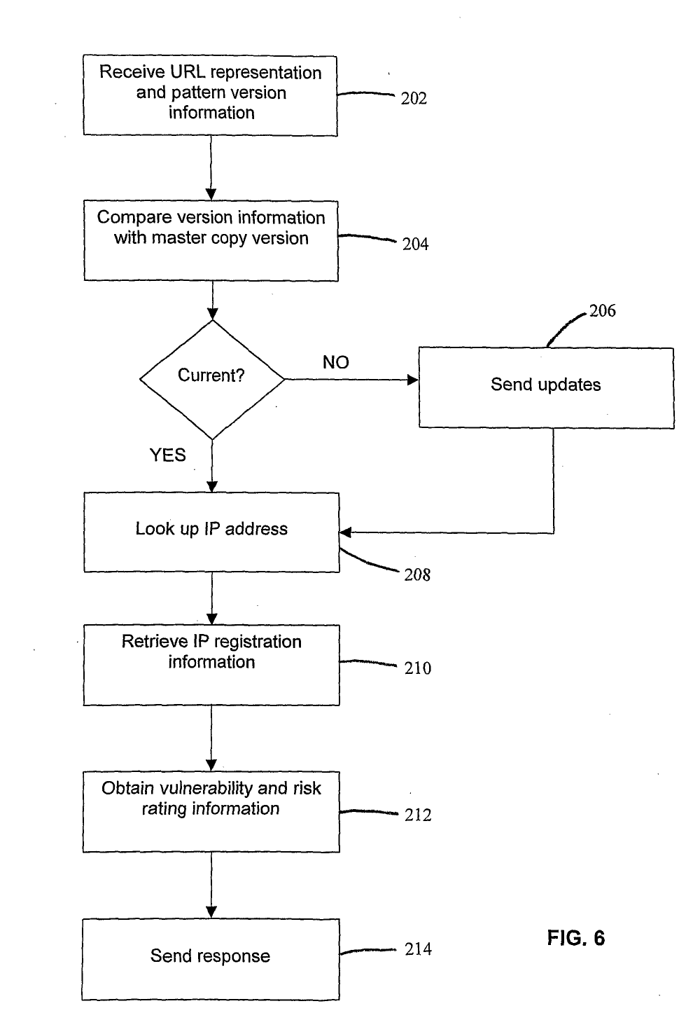

FIG. 6 is a flow diagram illustrating the processing performed by a security information server.

### OVERVIEW

The proposed security system takes the form of an extensible and adaptive web based database system. It is intended to defeat a popular form of fraudulent attack on web based banking systems, and also provide significant ancillary benefits in the form of additional security, an Internet-wide community or neighborhood watch scheme, and considerably enhanced marketing opportunities.

The security system is illustrated in overview in FIG. 1.

A plurality of user terminals 10 (for example, general purpose personal computers) are connected to a network 16, in the present example the Internet, through which they can access a variety of information. An Internet browser application 12 (also referred to simply as a web browser) is provided on each terminal to manage the access to the resources available through the Internet, in particular via the World-Wide Web.

Associated with each web browser 12 is a security component 14. A security information server 18 is also connected to the Internet.

The security component 14 interacts with the web browser to provide security information to the user of the browser regarding web sites visited by the user. In particular, the security component 14 performs a number of checks on any URL (Uniform Resource Locator) entered by the user. Firstly, the component 14 performs local checks to determine whether a URL matches certain criteria. Secondly, the component carries out remote checks by communicating with the security information server 18 via the Internet 16.

The security information server 18 stores information relating to the security of web sites on the Internet, which can be sent to the security component 14 on request. This information includes a blacklist of URLs or web sites which are known to have security risks associated with them, for example because they are involved in known phishing attacks. A local copy of this blacklist is held by the security component 14. Updates to this local copy are received regularly from the security information server 18.

Furthermore, the user of the security component 14 can provide security information to security information server 18, in particular by reporting web sites that the user considers to be suspicious. Such user feedback is stored in the database and is then available to other users of the system.

In a preferred embodiment, the security component 14 comprises a toolbar which can be integrated into the web browser application 12.

Toolbars are software components which provide a grouping of user interface features such as selection boxes, input fields and buttons, along with associated functionality. Toolbars can be provided as add-in components (also called “plug-ins”) to existing software applications to enhance the applications' functionality. For example, web browsers such as Netscape Navigator™ and Microsoft Internet Explorer™ allow toolbars to be installed as part of the browser to perform additional functions that the browser's creator has considered too specialised to implement natively within the browser itself.

Examples of toolbars available for Microsoft Internet Explorer™ include the Alexa toolbar (developed by Alexa Internet) and the Google toolbar (provided by Google, Inc.).

As described above, the toolbar provides both local and remote checking of URLs requested by the user.

Local checking involves determining whether the URL conforms to certain criteria, either by corresponding to a particular character pattern or by appearing in the local copy of the blacklist listing web sites associated with known risks.

In particular, the local checks involve detecting suspicious characters or character patterns which might indicate that the URL is associated with some kind of fraud attempt. The “1” and “% 01” characters discussed above are examples of such characters.

The toolbar can trap these suspicious URLs, and highlight them as dangerous. It can further report such URLs to a central database managed by the security information server 18, from where they can in turn be reported to the bank and hosting locations as appropriate.

The local checks further include checking the URL against a locally held blacklist of Internet addresses known or suspected to be associated with security risks such as phishing attacks.

Each URL visited by a user is checked against the local copy of this blacklist. If the URL visited is one which has been reported as suspicious by other users, or which has been identified as having a security risk associated with it, it will be found in the blacklist and a suitable warning message is then displayed. As is described below in more detail, a single character pattern matching mechanism may be provided to detect both suspicious characters and specific blacklisted URLs.

The toolbar also communicates with the security information server 18 to obtain additional information about each URL visited by the user (for example, the hosting location of the URL) and to obtain updates to the local copy of the blacklist from a master copy stored in a central database at the server 18.

In alternative implementations, the toolbar does not store a local copy of the blacklist. Instead, the toolbar reports each URL requested by a user to the server 18, where it is checked against the blacklist stored in the central database. If the reported URL is one which has been reported as suspicious by other users, this is immediately reported back to the toolbar to enable a warning message to be displayed.

As mentioned above, the toolbar also provides a feedback mechanism with which users can report web sites which are considered suspicious to the security information server. These web sites can then be added to the central copy of the blacklist. Through periodic updates of locally held copies of the blacklist, individual toolbars are then made aware of this new security risk.

The very fact that phishing attacks are usually carried out on a large scale (that is, the attackers will typically send many thousands or even millions of e-mails in the expectation that some will reach customers of the bank), means that the chance of a fraudulent web site being reported quickly is increased, which in turn expedites reporting of the fraud attempt to the bank or other organisation, its customers, and hosting locations. The users of the toolbar are effectively mobilised into a large cooperative watch scheme, where once the first recipients of the fraud have reported it, this information is available to other recipients of the attack as they access the URL.

### Implementation

The implementation of the security system will now be described in more detail with reference to FIG. 2.

As described above, the system comprises two main components: a security component that resides on each user computer and is active whenever the user is browsing the web using web browsing software (implemented, in the present example, as a toolbar) and a security information server including a database, which must be able to respond quickly to large numbers of requests as each of the system's users moves around the world-wide web.

Toolbars are typically implemented using an API (application program interface) made available by the web browser provider, and/or toolbar building toolkits available from third party suppliers. The toolbar may, for example, be implemented as a Browser Helper Object.

The central server (in practice, this can comprise multiple computers, potentially spread over multiple locations; it will be referred to herein simply as the central server, as it is a logical unit of functionality) maintains information on the state of the user community and the system's knowledge about URLs and sites visited by the community.

Communication between the toolbar and the central server uses the HTTP protocol, as well as the SSL protocol (which is essentially encrypted HTTP) for any information where the sensitivity merits the computational overhead of the encryption operations.

Much of the functionality of the system could in principle be performed either on the users' local machine by the toolbar, or by sending data to the central server. The location of the processing is decided by efficiency considerations.

As described above, user terminal 10 communicates with central server 18 via the Internet 16 in order to obtain security information relating to URLs visited by a user of the user terminal.

Specifically, the user terminal 10 comprises a web browser application 12, for example Microsoft Internet Explorer™ or Netscape Navigator™. The toolbar component 14 is associated with web browser 12 and communicates with the web browser to provide security information. The toolbar component 14 maintains a pattern store 22, for storing one or more character patterns used to identify suspicious URLs. The character patterns may, for example, specify particular characters or character sequences whose appearance in a URL may indicate a security risk.

In a preferred embodiment, the character patterns are used to identify both suspicious characters (such as the “@” and “%01” characters discussed above) and entire URLs to which access is to be restricted.

To this end, each character pattern specifies characters or character sequences, and may include wildcards. This allows greater flexibility in blocking not only specific characters and specific URLs, but also related groups of URLs. For example, a pattern such as “http://www.website.com/*”, in which “*” is a wildcard, may be used to effectively block an entire website, since it will match any URL beginning with the text preceding the “*” wildcard. As a further example, in the pattern “http://*.website.com/*”, the portion of the URL identifying the sub domain has been replaced by a wildcard. In this way, all sub domains of a given domain (here, domain “website.com”) can be blocked. For greater flexibility, other types of wildcards may also be used (such as single character substitution wildcards).

The above approach can be particularly effective where a phishing attack uses varying URLs (for example, such an attack could use URLs personalised to each victim). Particular URLs may, of course, be blocked simply by specifying the entire URL as a character pattern without wildcards (for example, “http://www.website.com/phishing/index.html”).

Central server 18 manages a security information database 20 which stores security information relating to web sites. This includes the master copy of the character patterns specifying the URLs which are considered to be associated with security risks. As mentioned above, a copy of the character patterns is also maintained by the toolbar component 14 and kept up to date by a periodic update procedure.

In use, a user enters a URL into web browser 12 (for example by keyboard input or by clicking on a link). Before displaying the requested web site, the web browser 12 passes the URL to the toolbar component 14 for checking. The toolbar performs both local and remote checks to obtain security information and to determine whether any security risks are associated with the URL entered.

Firstly, the toolbar component attempts to match the URL against the character patterns stored locally in pattern store 22. If the URL matches one of the stored patterns, the user is alerted by display of relevant information in the toolbar, and the toolbar instructs the browser 12 not to proceed with loading the web site specified by the URL but to display suitable warning information instead. The URL is thereby effectively blocked, though the user is given the opportunity to override the blocking and access the blocked site if required.

Secondly, the toolbar sends a token representing the URL via the Internet to security information server 18. The representation of the URL may simply be the URL string itself. However, for privacy reasons, it may not be desirable to report each URL in full to the security information server 18. In preferred embodiments, the toolbar therefore transmits an encoded representation of the URL. The encoded representation comprises the protocol, host, domain and, if applicable, port information from the URL in clear text, together with a check sum or hash code of the remainder of the URL.

For example, the URL “http://www.example.com/users/private” would be transmitted to the security information server as “http://www.example.com” in clear text together with a hash code or check sum of the remainder “/users/private”. The check sum or hash code may be generated using any suitable algorithm, such as, for example, MD5. Alternatively, a check sum or hash code of the entire URL could be used.

This ensures that sensitive personal information which is often contained in URLs is not recorded by the security information server.

Other suitable representations of URLs may also be used, and any reference herein to resource locators or URLs shall be taken to refer also to any such representations of resource locators or URLs, as is appropriate in the context.

Security information server 18 looks up the representation of the URL in security information database 20 and returns any relevant security information relating to that URL. This may include information regarding known vulnerabilities, information relating to the hosting location of the URL and/or information regarding a risk level associated with the URL (calculated as described below).

This information is displayed by the toolbar 14. Then, if the URL is not to be blocked, the toolbar instructs the web browser 12 to load and display the requested page.

### The Toolbar

The toolbar will now be described in more detail with reference to FIGS. 3 to 5.

FIG. 3 illustrates, in a simplified manner, the visual appearance of a web browser using a security toolbar as described herein.

The web browser executing on the user terminal displays a browser window 40, including common browser interface components such as a menu bar 42, an address bar 44 for entering and displaying URLs, a browsing toolbar 46 containing buttons for standard browsing functions such as back, forward, stop and home, and a page display area 48. The user accesses a new web page typically either by entering a URL into address bar 44 or clicking a link in page display area 48 (other ways of selecting web pages may also be provided, for example by way of a “favourites” menu or history list). The web browser then fetches the web page corresponding to the URL entered and displays it in display area 48. The security toolbar 50 provides functions relating to URL checking and security information display.

FIG. 4 illustrates the appearance of the toolbar in more detail, again in a simplified manner and purely by way of example.

Toolbar 50 comprises a logo display area 52 for displaying a name, logo or other indication of the toolbar provider. This may, for example, be a financial institution. In the present example, the (fictitious) name “FakeBank” is shown.

The toolbar further comprises a button 54 for reporting a suspicious web site and a further button 56 for requesting further security information relating to a web site. In the example, these are labelled with an exclamation mark and a question mark respectively, but they may of course be labelled with any suitable graphic or text label or a combination of the two.

A status display area 58 of the toolbar 50 provides a summary of the security status of the web site currently being accessed, stating whether any known security vulnerabilities are associated with the web site, giving a risk rating calculated for the web site (60), and giving the country (62) and name (64) of the company to which the IP address corresponding to the URL is registered. The risk rating may, for example, be displayed in a graphical representation. The country may, for example, be indicated by displaying a flag image.

The toolbar may also provide further functions, for example by way of further buttons or by way of a menu accessible by right-clicking on the toolbar.

The toolbar receives an event notification from the web browser when the user requests a new URL. As previously described, the toolbar then performs both local and remote checking on the URL, firstly by pattern matching against locally stored character patterns and secondly by obtaining security information from the security information server.

Upon receiving the event notification stating that a new URL has been requested, the toolbar attempts to match the URL against patterns of dangerous URLs. These patterns are supplied to the toolbar by the security information server. In principle, patterns can be maintained through a general software update mechanism (as described below), or through a separate protocol of request/responses to the security information server.

For performance reasons, it is preferred that this pattern matching is performed locally on the user's computer. This can also reduce vulnerability of the whole system to failure of the security information server (for example as a result of a malicious Denial of Service attack). However, the pattern matching may also be performed centrally at the security information server, or the processing may be split, for example with the toolbar checking only for suspicious characters, and the server checking the URL against a URL blacklist. In that case, it may be sufficient for the toolbar to poll the security information server for updates to the patterns when the web browser application starts up.

As mentioned above, phishing attacks often involve opening the authentic web page of the bank or other organisation in the background, with the fake web page relating to the attack displayed in the style of a pop-up window in front. The pop-up window will usually suppress display of the menu bar, address bars and toolbars that are normally displayed in a browser window (as is usually the case for advertising pop-up windows and the like), so that the user cannot see the URL of the page being displayed and is led to assume that it, like the bank's web page behind, is authentic. Naturally, the user would also be unable to see the security toolbar in this case.

A further feature of the toolbar is therefore that it forces display of at least the address bar and security toolbar in every browser window, including pop-up windows.

The processing performed by the toolbar is summarized in FIG. 5.

At step 102, the toolbar receives a URL from the web browser for checking. At step 104 the toolbar compares the URL to the character patterns stored in the pattern store. If a match is found, indicating, for example, that the URL relates to a web page which has been flagged in the security information database as potentially dangerous, then an alert is displayed and/or the web page referred to by the URL is blocked at step 106.

A representation of the URL is then sent to the security information server in step 108. This representation includes the protocol, name and port (if any) of the web site referred to by the URL as described above. The toolbar also sends version information identifying the version of the local copy of the URL character patterns. This may, for example, identify the date and time at which the local copy of the patterns was last updated.

The toolbar receives a response from the security information server at step 110 in the form of security information relating to the URL. If necessary, the security information server may also send update information relating to the local copy of the URL character patterns. This may, for example, include any patterns which have changed or have been added to the master copy of the pattern list held at the security information server since the last update, and information identifying any patterns which have been removed from the master copy of the pattern list. The toolbar updates its local copy of the patterns accordingly.

The security information received from the security information server is displayed in the status display area (58) of the toolbar in step 114.

The alerting of the user and blocking of the web page is achieved by displaying a warning message which has to be acknowledged by the user before the page can be displayed. The warning message may, for example, include a statement that the page has been blocked and why, a link via which the user can report that the web page has, in the user's opinion, been incorrectly flagged as dangerous, and a link via which the user can gain access to the blocked page despite the security warning. The warning message may, for example, be presented in the page display area 48 of the web browser window 40 in the form of a warning page displayed in place of the actual web page referred to by the URL.

If the checks did not indicate that the web page should be blocked, then the web browser downloads and displays the requested page as normal.

Optionally, to improve performance, the toolbar may cache the information received in respect of a particular web site for a short period, such as 5, 10 or 15 minutes, though longer periods may also be used (such as half an hour or an hour). In a preferred example, the toolbar caches the information for up to 14 minutes.

In addition to its primary security-related functions, the toolbar also provides the following additional functionality:

Version management: On start up the toolbar checks with a software update server to determine whether a new version of the toolbar is available, and offers to download and install the new version if this is the case (the software update server may be incorporated into the security information server or may be separate).

Branding: The toolbar can further provide branding and navigational functionality relevant to the toolbar provider. For example, the provider of the overall security system and of the toolbar software could license the toolbar and reporting functionality to organisations such as banks, financial institutions, and e-commerce companies, offering them the ability to brand the toolbar with their own logos, brands and identifying marks, to provide shortcuts to their own services and to bring new information and offers to the attention of its customers via the toolbar. Such licensees would typically pay an annual license fee for the services provided, for example based on the number of customers of the licensee using the services.

In addition to the fraud fighting attributes which would reduce financial loss to the banks or e-commerce sites and their customers, the toolbar can therefore provide an attractive branding and customer loyalty mechanism for the provider, keeping their logo and services on screen throughout the time the customer spends using the web.

License management: For commercial flexibility, the opportunity to grant licenses to organisations covering a particular time frame may be desirable. This can be achieved by providing license management functionality, whereby the toolbar checks with a central server (such as the software update server described above) on start up to determine if a license period has been exceeded, and disables the toolbar if it has.

Tell a friend: The system provider may wish to encourage deployment of the toolbar to proliferate as quickly as possible. In this respect, the toolbar could include “Tell a friend” functionality to enable users to more conveniently recommend its adoption to their friends and colleagues, for example by way of automatic e-mailing to one or more e-mail addresses entered by the user.

### The Security Information Server

The security information server will now be described in more detail with reference to FIGS. 2 and 6.

As shown in FIG. 2, the security information server 18 manages the security information database 20, which stores various types of security information relating to web sites and web pages, including the master copy of the list of URL character patterns used to identify potentially dangerous URLs, such as URLs which have been previously reported by the system's user community. As already mentioned, in a preferred embodiment, the toolbar 14 maintains its own local copy of this pattern list.

The security information server 18 also processes security information requests received from toolbars.

Each such request includes a representation of the URL for which information is required. This representation typically includes the protocol, name and port (if any) of the web site referred to by the URL.

In embodiments where a single central URL character pattern list is stored by the security information server, the server also performs the step of comparing this URL representation with the URL character patterns. In this case, the patterns corresponding to URLs may be stored in a representation corresponding to the representation of URLs received from the toolbars, in which case a direct comparison may be performed. Alternatively, the database may store reported URLs in clear text, in which case the comparison step may comprise generating the equivalent representation (including the check sum or hash code) of URLs specified in the pattern list and comparing the generated representation to the URL representation received. Normally the results of this comparison will be negative, in which case the browser continues its normal action. However, if the user requests a URL which appears in the list of potentially dangerous URLs, then the security information server notifies the toolbar of the match, and the toolbar alerts the user to the circumstances.

In embodiments where the toolbar maintains a local copy of the URL character patterns, the above check is performed locally by the toolbar as already described. However, in that case, the security information server 18 also receives version information from the toolbar identifying the version of the toolbar's local copy of the character pattern list (for example by identifying the time and date at which this was last updated), and transmits any necessary update information with its response.

In either case, the security information server 18 uses the received URL representation to retrieve security information relating to the web site in question from the security information database 20, and transmits this security information to the toolbar for display.

In a preferred embodiment, four main types of security information are managed by the security information server: user reporting information; hosting location information, vulnerability information and risk assessment information. These will now be described in more detail. However, it should be noted that embodiments need not use all of the described types of information, and may additionally or alternatively use other types of security information not described here.

User reporting information: As described above with reference to FIG. 4, the toolbar 50 comprises a button 54 for reporting web sites believed to be in some way suspicious. When a knowledgeable and experienced user visits a previously unreported URL that he believes to be related to a fraud such as a phishing attack, he can report this using the reporting button on the toolbar. The security information server then records this information against the URL and may additionally flag the URL for review, highlight it as a threat to any other community members visiting the URL, or wait for corroborating reports from other members of the community, or review from a system administrator. After any necessary corroboration/review, a reported URL can be added as a character pattern to the master copy of the character patterns stored in the security information database, from where it can then be passed to local copies stored by individual toolbar clients using the previously described update process. The system operator may of course decide to add a generalised character pattern (e.g. using a wildcard) to capture not only the specific reported URL but also other URLs referring to the same web site.

Additionally, to deal with mistaken or malicious reporting of benign URLs, the user may also be given the capability to report any URL that he thinks has been incorrectly classified as dangerous.

As the volume of reports requires, user identifiers can be allocated for reporting users so that past reliability of reporting can be used to corroborate future reports. In a preferred embodiment, the system uses e-mail addresses to identify individual users, and requests a user's email address when the user reports a suspicious site.

Because of the financial importance of the information, each reported URL would typically be inspected by a system administrator and, if validated, reported to the appropriate bank, hosting location, and law enforcement agency. The system administrator has the ability to outvote any and all reports on given dangerous URLs, as once the system becomes widely adopted, it is conceivable that fraudsters could register as users of the system to affect the user feedback concerning their own URLs.

Hosting location information: Additionally, the security information database stores information relating to the hosting location of web sites.

More specifically, the database stores IP registration information relating to IP addresses, which includes information indicating the company or person to whom a given IP address (or IP address range) is registered. For a given URL, the IP address of the host on which the web page referred to by the URL resides can be determined by DNS server lookup. Registration information relating to that IP address can then be obtained from the security information database. By displaying this information on the toolbar the victim of an attack can immediately see that the IP address of the web page he is visiting—which appears to be associated with his bank's real web site—is not actually registered to his bank (and is potentially even registered in a different country).

The registration information for IP addresses is obtained from the various IP address registries worldwide, typically in the form of regular snapshots of the registries' registration data (for example on a daily or monthly basis). This information can be used to derive the registered owner and country of each IP address on the Internet.

For efficiency purposes, instead of automatically retrieving this information and forwarding it to the toolbar for display in response to a request, an additional button could be provided on the toolbar via which the user can specifically request this information.

If the site being viewed is in the DNS (Domain Naming System), the user can also be given the option of requesting the system to look up the domain name registration details of the site's domain, as corroborating evidence that the site is not, in fact, related to his bank.

Risk assessment information: The toolbar displays a “risk rating” for each site visited, which, in a preferred embodiment, is a score from 0 to 10 that gives an indication of the likelihood that the site is involved in a phishing attack or similar fraudulent activity. A higher score typically indicates a greater likelihood that the site is involved in fraudulent activity.

The risk rating is preferably displayed in the toolbar in visual form, for example as a slider graph, giving a clear visual indication of the risk level of the site currently being viewed. The risk rating is calculated by the security information server, based on the details of the web site passed by the toolbar. The calculation is performed by combining several factors based on the hostname, IP address and port of the site, combined with data concerning known phishing sites and other information held by the server. These factors include:
Whether a hostname or a raw IP address is used in the URL.
Whether or not a numerical port is specified in the URL.
Whether or not any known phishing sites share the domain name of the site in question.
The density of known phishing sites vs. sites as a whole in the country in which the site's IP address is registered.
The density of known phishing sites vs. sites as a whole for the organisation registered as the owner of the IP address of the site.
The density of known phishing sites vs. sites as a whole for the top level domain or publicly registrable point under which the site's domain name appears.
How long ago this site was first seen in an information gathering survey conducted by the security information server or an associated information gathering system, and how long ago the domain name of the site first appeared in such a survey. The longer a site has existed, the less likely it is to be a phishing/fraudulent site.

Weightings may be associated with the various factors, which may be recalculated (preferably automatically) whenever a new phishing site becomes known, or as new information about web sites is discovered during automated web server surveys. In this way, a self-adjusting ratings mechanism can be provided.

Since, in preferred embodiments, the full URL is not transmitted to the security information server for privacy reasons (instead, a token representing all or part of the URL may be transmitted together with information such as protocol, host name and port), the risk rating may, for example, be based on the hostname and port parts of the URL only. In some embodiments, the toolbar itself may additionally calculate a risk rating modifier by locally checking the full URL for patterns that suggest a phishing attack or other fraudulent activity. This modifier can then be combined with the risk rating received from the security information server to give an overall risk rating.

Vulnerability information: The security information database can also store vulnerability information relating to security vulnerabilities which are believed to be present in particular web sites. The vulnerability information is intended to be consistent with what an expert can infer from publicly available information published by the site. Examples of vulnerabilities include weaknesses or bugs in operating system and web server software which can be exploited by attackers.

Fraudulent activities such as phishing attacks are sometimes run from compromised servers without the knowledge of the server's owner. In some cases, cross-site scripting and open redirectors have been used to run phishing attacks from banks' own web sites. Knowing whether a web site has security vulnerabilities (and therefore might be under the control of or abused by a criminal) can therefore be helpful to the user.

Additionally, the general security of Internet commerce sites is much poorer than a layman might reasonably expect, with many commerce sites operating on versions of software widely known to be vulnerable.

As an example, some criminals have been known to break into e-commerce sites, and install monitoring programs to record financially useful information such as credit card and bank account details as they are entered into the site. Honeynet, a consortium of Internet security administrators, have shown that the carding community (a community of criminals operating in this field) operate exchanges where control of compromised e-commerce sites is traded along with actual card details harvested from the sites, while according to the UK banking association APACS, Internet card fraud grew by 86% during 2002.

Knowing that a site is likely to be vulnerable would be useful for the user to help identify sites that might be under the control of criminals, or where criminals might easily obtain control in the near future. Displaying information relating to known security vulnerabilities can therefore also aid a user in making an informed decision as to whether to trust the security of a commercial web site before supplying sensitive information such as credit card details to it.

It is generally not practical for the system to extensively test sites for security vulnerabilities, as this is indistinguishable to the site from an actual attack. However, it is reasonable for the system to interpret information conventionally published by the site, to see if this contains any information that might indicate that the server is vulnerable. Information in this class would include the name of the web server software and the software version, the type and version of the operating system, any of the web server module names and versions, and any information that can be determined from retrieving the front page of the site.

Some “false positive” reporting (where the site has actually patched a security vulnerability, but continues to publish a version number that is known to be vulnerable) is likely to occur when the recommendation is primarily based on product and version information published by the site. However, some well known credit card, banking and commerce web sites have the security of their sites tested in depth by specialist Internet security firms, and for these sites, any such additional information available can be added to the security information database to give a more accurate opinion on the site's security. Such information may then give users an extra degree of confidence in the security of the web sites in question.

To obtain vulnerability information, the security information server examines each web site which has in the past been accessed by members of the user community and compiles an assessment of its security using information that it maintains relating to known vulnerabilities of web server and operating system software.

It is generally preferably to wait until a community member accesses a given page before analysing it for security vulnerabilities, since there is no need to evaluate a web site that is not visited. A timestamp is taken at the point of the evaluation and this is stored together with the results of the evaluation so that the information can be stored for a suitable period (say 24 hours) before considering whether it should be re-evaluated. Due to the large number of web pages that would potentially need to be evaluated, a performance gain could be achieved by limiting the number of pages taken from any one web site (for example, by taking a logarithmically decreasing sample after the first 100 distinct page requests relating to a given web site).

Assessments are primarily formed using rules which apply to the web server headers and page content visible on a conventional page request, but could additionally include information from knowledge of previous site security breaches (obtained, for example, from defacement archives), and other security testing services where used by the web site in question. Users can thus be presented with an informed opinion on the security of the web sites they are visiting.

Although the security vulnerability information relating to a given URL could be obtained dynamically by carrying out a vulnerability assessment in response to a request received from a toolbar, for efficiency and performance reasons it is preferable to perform assessments independently of the requests and to store the resulting vulnerability information in the database. For example, the security information server could perform vulnerability assessments on a daily basis, assessing any new web sites visited by users during the last day, as well as any existing web sites for which vulnerability information is already stored in the database, but which are due to be re-evaluated. Alternatively, the security information server could perform a dynamic vulnerability assessment only on those web sites for which information is not already available in the database.

As mentioned above, the hosting location information, vulnerability information and risk assessment/risk rating information associated with a URL is transmitted to the toolbar where it is displayed. Specifically, the toolbar displays a visual indication of the risk rating, a summary of the vulnerabilities found (possibly none), as well as the hosting location information (company name and country). If the web site in question is one which has been more fully tested, or for which no vulnerability information is available yet, then this is also indicated. Vulnerabilities may be classified according to severity, for example into problems and warnings, with problems being security vulnerabilities which could allow hackers to gain access to or control of the web server (and hence access to personal details stored there), and warnings being less severe vulnerabilities, for example relating to the possibility of Denial of Service attacks. The summary presented by the toolbar might then give the number of vulnerabilities of each type found, and provide the user with the option of viewing details of the vulnerabilities (using the information button 56 as shown in FIG. 4). In the example of FIG. 4, the status display area 58 of toolbar 50 displays a risk rating (60) (in this example, a rating of 5 on a scale of 0 to 8, represented graphically) and indicates that no known vulnerabilities are associated with the present web site (61) and that the IP address of the page being viewed is registered to “FakeBank pic.” (64) in Great Britain (62).

The processing performed by the security information server in response to an information request received from a toolbar is summarized in FIG. 6.

At step 202, the security information server receives a request containing a representation of a URL to be checked, along with version information identifying the version of the local copy of the URL character patterns held by the toolbar in pattern store 22. At step 204, the server compares the version of the local copy held by the toolbar with the version of the master list stored in security information database 20. If the toolbar is holding an out-of-date copy, updates are sent to bring the client up-to-date at step 206.

At step 208, the server performs a DNS lookup to determine the IP address associated with the URL (this being the IP address of the host referred to by the URL). It then retrieves IP registration information relating to the IP address from the database in step 210, in particular the name and country of the company to whom the IP address is registered. The country can, for example, be derived from the dialing code of a company telephone contact number given in the registration information, if the registration information does not itself indicate the country.

At step 212, the server retrieves vulnerability information relating to the web site from the database. This may be recorded in the database either against the domain and host name or the IP address of the web site referred to by the URL and looked up accordingly. Additionally, the server constructs the risk rating assessment relating to the web site. This may be calculated dynamically in response to the request or may be obtained from previously calculated risk rating information stored in the database.

A response comprising the security information is then transmitted to the toolbar at step 214, where the information is displayed to the user.

In alternative embodiments where a copy of the URL character patterns is not held locally at the toolbar, the server also compares the URL representation to the pattern list stored in the database, and transmits an alert in case of a match.

In a preferred embodiment, the security information transmitted at step 214 is only a summary of the information available in the database. For example, the security information server may simply indicate whether or how many security vulnerabilities are associated with a given web site, or whether a given web site should be considered a risk. By way of an information button on the toolbar (item 54 of FIG. 4), the user can request more detailed information, such as the exact types of any vulnerabilities detected, and detailed information concerning the organisation hosting the web site. Due to the limited screen space available to the toolbar, this detailed information may, for example, be displayed in the form of an HTML page in page display area 48 rather than in the toolbar itself.

In some embodiments, as an alternative or in addition to the information described above, the security information database 20 (shown in FIG. 2) may store a “safe” list of trusted banking-related web sites, in the form of lists of domain names and/or IP addresses or IP address ranges which are known to be registered to genuine banks and similar financial institutions. This safe list can be used to provide a “safe Internet banking” icon which is displayed on the toolbar whenever a trusted banking-related web site is visited by the user.

In a preferred embodiment, the security information database 20 stores both a list of known domain names and a list of known IP address ranges registered to banks and other financial organisations. When the security information server 18 receives a security information request from a toolbar including a URL (or a representation of a URL as described above), it compares the domain name of the URL to the list of known domain names stored in security information database 20. It also performs a DNS lookup to obtain the IP address associated with the URL as described above, and compares the IP address to the list of known IP address ranges stored in the database. The security information server then reports its findings back to the toolbar. This processing can alternatively be performed locally by the toolbar using a local copy of the list of known domain names and IP address ranges.

If the domain name or IP address is found in the relevant list, the toolbar then displays a graphical icon indicating that the web site being accessed is known to belong to a trusted banking organisation. This can give the user greater confidence that the web site being accessed is genuine and safe. The icon may be displayed if either the domain name or the IP address can be matched, or may only be displayed if both domain name and IP address can be matched. If neither the domain name nor the IP address are found in the database (or alternatively only one of them), then the icon is not displayed. If the user believes that he is accessing a banking web site, then the absence of the graphical icon in the toolbar should alert the user to the fact that the web site being accessed is not known to the system and therefore may not be genuine. Alternatively, a negative indication could be displayed.

The banking organisations themselves can educate their customers to check that this “safe banking” icon appears in the toolbar before providing any personal details or otherwise attempting to use a (supposedly) banking-related web site.

Before the system is first used, the database is populated with details of the domain names and IP address ranges registered to and used by known banks and similar organisations. This information may be obtained directly from the organisations concerned. Since this information may change over time as new domain names and IP addresses are allocated, it is necessary to update the information regularly.

To achieve this, the system may regularly look up the IP addresses associated with known domain names and add them to the IP address list if not already there. Furthermore, the system may use the IP registration information held in the security information database 20 (as described above) to search for new IP addresses or address ranges registered to known organisations, for example by comparing the name and address details of known organisations to the IP registration entries. If IP addresses are identified which are registered to a known organisation, these are added to the IP address list. Likewise, domain registration information may also be obtained and inspected to find newly registered domains.

In this way, an automatic update procedure may be provided to ensure that the lists of known “safe” domain names and IP address ranges remain up-to-date. This procedure may also be used when first populating the database. However, there may be a danger that such an automatic system could be abused, for example by an attacker registering a domain or IP address range using the name and address of a genuine organisation. To alleviate this problem, manual checks may be introduced whereby an operator checks the registration data, for example by telephoning the telephone number specified in the data and/or asking the organisation for confirmation of the registration, before a domain name or IP address is added to the safe list.

Since it will be in the banks' interests to keep their domain name and IP address information on the safe lists, it can be expected that they will endeavour to provide updated information to the provider/operator of the toolbar. This information can then be manually added to the database. Also, new banks or banks whose details do not yet appear on the safe lists may typically provide their information directly to the operator of the system for addition to the database, as otherwise their web sites may not be trusted by users of the toolbar.

Where the toolbar is provided by a particular banking organisation, the system may store only that particular bank's domain names and IP address ranges.

This system may be applied to web sites other than banking or financial web sites. For example, a “safe Internet shopping” icon could be provided which is displayed on the toolbar whenever a trusted Internet shopping web site is visited by the user. Generally speaking, the system may be applied to the kinds of web sites which are likely to be victims of “phishing” attacks, typically those which allow users to administer money or other tokens of value, or which handle sensitive personal information (such as credit card details).

As an additional feature, the security information server can maintain a log of web sites or URLs (or representations thereof) visited by users of the system, from which aggregated reports can be produced about the behaviour of the user community in the aggregate. The toolbar provider can thereby obtain valuable information about the behaviour of their customers on the World Wide Web.

In conclusion, important aspects of the security system described include:
Trapping of suspicious URLs containing characters which have no common purpose other than to deceive.
Convenience of reporting the fraud to the bank and to the hosting location.
Community watch behaviour of the system making warnings about fraudulent URLs immediately available to the rest of the community via display on the toolbar. Supervisor validation or a voting system can be used to reduce and eliminate the impact of false reporting of URLs.
Clear display of sites' hosting location at all times while the user browses the web.
Indication of security vulnerabilities and risk assessments or risk ratings relating to sites visited.
Augmenting fraud fighting functionality with branding and marketing to help the bank or other organisation communicate to its customers, by offering more expedient navigation to its own services, and to bring new information and offers to the attention of its customers.
Census quality information available to the bank or other organisation to learn about the web browsing behaviour of its customers in aggregate.

Adoption of the system could potentially change the chances of a successful fraud in the victims' favour and enable the banks' and other organisations' customers to defend themselves against fraud, as the user community is empowered to leverage the intellect and alertness of its most able members.

It will be understood that the present invention has been described above purely by way of example, and modification of detail can be made within the scope of the invention.

For example, specific processing described above as being performed at the user terminal by the toolbar could alternatively be performed by the security information server and vice versa. As an example of this (already described above), the security information server could perform all URL checking tasks including the character pattern matching.

In another example, the security information (such as the hosting location and vulnerability information described above) could be provided to the toolbar only on request, possibly under control of the information button on the toolbar.

Instead of a toolbar which is integrated into the web browser software, a separate software component could also be used which intercepts URL requests output by the browser. This could, for example, work at the operating system level. Alternatively, a URL rewriting proxy could also fulfil the functionality of the toolbar, and provide facilities independent of particular operating system and browser software.

Each feature disclosed in the description, and (where appropriate) the claims and drawings may be provided independently or in any appropriate combination.

1. A security component for use with an Internet browser application which displays Internet resources in response to resource locators specifying the Internet resources, the security component being adapted to operate alongside the Internet browser application at a user terminal; the security component comprising:
means for storing a plurality of resource locator patterns, each resource locator pattern matching one or more resource locators relating to Internet resources known or believed to be associated with security risks;
means for receiving a resource locator from the browser application;
means for comparing the received resource locator to the stored resource locator patterns; and
means for providing a security alert if the received resource locator matches one of the stored resource locator patterns.

2. A component according to claim 1, wherein the resource locators are character strings and the resource locator patterns are character patterns.

3. A component according to claim 2, wherein the comparing means comprises means for testing the resource locator for the presence of one or more characters specified by a character pattern.

4. A component according to claim 1, adapted to process a pattern comprising one or more wildcards or placeholders.

5. A component according to claim 1, further comprising means for receiving pattern update information; and means for updating the resource locator patterns stored by the storing means in response to the update information.

6. A component according to claim 1, further comprising means for transmitting a representation of the resource locator to a security information server, and means for receiving security information relating to the resource locator from the security information server.

7. A component according to claim 6, wherein the representation comprises a check sum or hash code of at least part of the resource locator, further comprising means for generating the check sum or hash code.

8. A component according to claim 6, wherein the security information comprises a risk rating specifying an estimate of security risk associated with the resource locator.

9. A component according to claim 6, wherein the security information comprises an indicator indicating whether the resource locator is associated with a trusted Internet location.

10. A component according to claim 6, wherein the security information comprises IP registration information relating to an IP address with which the resource locator is associated.

11. A component according to claim 6, further comprising means for displaying the security information.

12. A component according to claim 1, wherein the alerting means is adapted to prevent the Internet browser application from displaying the Internet resource specified by the resource locator.

13. A component according to claim 1, further comprising means for receiving an indication of a suspected security risk from a user of the Internet browser application relating to an Internet resource viewed by the user, and means for transmitting the indication to a security information server.

14. A security component for use with an Internet browser application which displays Internet resources in response to resource locators specifying the Internet resources; the security component comprising:
means for receiving a resource locator from the browser application;
means for transmitting a representation of the resource locator to a remote server;
means for receiving IP registration information relating to the resource locator from the remote server; and
means for displaying the IP registration information.

15. A security component according to claim 14, comprising a user interface for user interaction with the security component, the user interface being adapted to be integrated into the user interface of the Internet browser application.

16. A security component according to claim 15, wherein the user interface comprises a display area for displaying security information relating to the resource locator.

17. A plug-in for an Internet browser application comprising a component as claimed in claim 1.

18. A toolbar for an Internet browser application comprising a component as claimed in claim 1.

19. A security information server comprising:
a database of security information relating to Internet locations;
means for receiving a security information request comprising a representation of a resource locator from a user terminal;
means for retrieving security information relating to the resource locator from the database; and
means for transmitting the security information to the user terminal.

20. A security information server according to claim 19, further comprising:
means for receiving security information relating to a specified resource locator from a user terminal; and
means for updating the database in dependence on the security information received.

21. A security information server according to claim 19, wherein the database is adapted to store a plurality of resource locator patterns, each resource locator pattern matching one or more resource locators relating to Internet resources known or believed to be associated with security risks.

22. A security information server according to claim 21, further comprising means for receiving an indication of a suspected security risk relating to a specified resource locator from a user terminal; and means for adding a resource locator pattern matching the specified resource locator to the stored resource locator patterns.

23. A security information server according to claim 21, further comprising means for receiving pattern version information from a user terminal specifying the version of a local copy of the resource locator patterns held at the user terminal, and means for transmitting pattern update information to the user terminal in dependence on the version information to update the local copy of the resource locator patterns.

24. A security information server according to claim 19, further comprising means for calculating a risk rating specifying an estimate of security risk associated with an Internet resource or location referred to by the resource locator, and means for transmitting the calculated risk rating to the user terminal.

25. A security information server according to claim 19, wherein the database is adapted to store information relating to suspected security vulnerabilities associated with an Internet location.

26. A security information server according to claim 25, further comprising means for assessing whether potential security vulnerabilities are associated with an Internet location.

27. A security information server according to claim 26, wherein the assessing means is adapted to identify potential security vulnerabilities in dependence on one or more of: the operating system of a web server associated with the location, the version of that operating system, the web server software used by the web server, and the version of that web server software.

28. A security information server according to claim 19, wherein the database is adapted to store registration information relating to a plurality of IP addresses, and wherein the retrieving means is adapted to retrieve registration information relating to an IP address associated with the received resource locator representation.

29. A security information server according to claim 28, wherein the registration information comprises information relating to the organisation or person to whom the IP address is registered.

30. A security information server according to claim 19, wherein the database is adapted to store information relating to trusted Internet locations, the security information server further comprising means for determining whether the received resource locator representation relates to a trusted Internet location, the transmitted security information comprising an indicator indicating whether the received resource locator representation relates to a trusted Internet location.

31. A security information server according to claim 30, wherein the information comprises a list of trusted domain names.

32. A security information server according to claim 30, wherein the information comprises a list of trusted IP addresses or IP address ranges.

33. A security information system comprising a security information server as claimed in claim 19 and a plurality of user terminals each comprising a security component, wherein the security component comprises:
means for storing a plurality of resource locator patterns, each resource locator pattern matching one or more resource locators relating to Internet resources known or believed to be associated with security risks;
means for receiving a resource locator from the browser application;
means for comparing the received resource locator to the stored resource locator patterns; and
means for providing a security alert if the received resource locator matches one of the stored resource locator patterns.

34. A method of providing security information to a user of an Internet browser application which displays Internet resources in response to resource locators specifying the Internet resources, the browser application residing at a user terminal, the method comprising:
storing, at the user terminal, a plurality of resource locator patterns, each resource locator pattern matching one or more resource locators relating to Internet resources known or believed to be associated with security risks;
receiving a resource locator from the browser application;
comparing the resource locator to the stored resource locator patterns; and
providing a security alert if the resource locator matches one of the stored resource locator patterns.

35. A method according to claim 34, wherein the resource locator is a character string, and the resource locator patterns are character patterns.

36. A method according to claim 35, wherein the comparing step comprises testing the resource locator representation for the presence of one or more characters specified by a character pattern.

37. A method according to claim 34, further comprising receiving, at the user terminal, pattern update information; and
updating the plurality of stored character patterns in response to the update information.

38. A method according to claim 34, further comprising:
maintaining, at a security information server, a database of security information relating to Internet locations;
retrieving security information relating to the received resource locator from the database; and
displaying the security information at the user terminal.

39. A method according to claim 38, further comprising: storing, at the security information server, a plurality of resource locator patterns, each resource locator pattern matching one or more resource locators relating to Internet resources known or believed to be associated with security risks, and transmitting the resource locator patterns to the user terminal.

40. A method according to claim 39, further comprising receiving an indication of a suspected security risk relating to a specified resource locator from a user terminal; and adding a resource locator pattern matching the specified resource locator to the plurality of resource locator patterns stored at the security information server.

41. A method according to claim 39, further comprising:
transmitting pattern version information from the user terminal to the security information server identifying the version of the local copy of the resource locator patterns held at the user terminal, and
transmitting pattern update information from the security information server to the user terminal in dependence on the version information to update the local copy of the resource locator patterns.

42. A method according to claim 38, comprising calculating, based on information stored in the security information database, a risk rating specifying an estimate of security risk associated with an Internet resource or location represented by the received resource locator, and displaying the calculated risk rating at the user terminal.

43. A method according to claim 38, further comprising storing information relating to suspected security vulnerabilities associated with an Internet location in the database.

44. A method according to claim 43, further comprising assessing an Internet location to determine whether potential security vulnerabilities are associated with the location, and storing the outcome of the assessment in the database.

45. A method according to claim 44, wherein the assessing step comprises identifying potential security vulnerabilities in dependence on one or more of: the operating system of a web server associated with the location, the version of that operating system, the web server software used by the web server, and the version of that web server software.

46. A method according to claim 38, further comprising storing registration information relating to a plurality of IP addresses in the database, and wherein the retrieving step comprises retrieving registration information relating to an IP address associated with the received resource locator.

47. A method according to claim 38, further comprising storing information relating to trusted Internet locations in the database, and wherein the retrieving step comprises determining whether the received resource locator relates to a trusted Internet location.

48. A method according to claim 47, wherein the information comprises a list of trusted domain names.

49. A method according to claim 47, wherein the information comprises a list of trusted IP addresses or IP address ranges.

50. A method according to claim 34, wherein the alerting step comprises preventing the Internet browser application from displaying the Internet resource specified by the resource locator.

51. A method of providing security information to a user accessing via the Internet accounts for holding or managing money or other tokens of value, comprising:
storing domain names and/or IP address information relating to trusted Internet sites providing access to such accounts;
receiving a resource locator specifying an Internet resource requested by the user;
determining whether the resource locator relates to a trusted Internet site by comparing a domain name or IP address associated with the resource locator to the stored domain names and/or IP address information; and
outputting a corresponding indication to the user if it is determined that the resource locator does relate to a trusted Internet site.

52. A component, plug-in or toolbar for an Internet browser application adapted to carry out a method as claimed in claim 34.

53. A security information server adapted to carry out a method as claimed in claim 34.

54. A computer, program or computer program product comprising a security component as claimed in claim 1.

55. A computer program or computer program product comprising software code adapted, when executed on a data processing apparatus, to perform a method as claimed in claim 34.

56.-59. (canceled)
